(19) United States
(12) Patent Application Publication
(10) Pub. No.: US 2026/0086877 A1
(43) Pub. Date: Mar. 26, 2026

(54) COMPUTING RESOURCE ECONOMIZED CONTAINER-BASED VIRTUALIZATION

(71) Applicant: INTERNATIONAL BUSINESS MACHINES CORPORATION, Armonk, NY (US)

(72) Inventors: Bo LIU, Pudong New District (CN); Xiao Ling CHEN, Changping District (CN); Meng Lu WANG, Beijing (CN); Le YUE, Beijing (CN); Zhi Qian TAN, Shanghai (CN)

(21) Appl. No.: 18/891,162

(22) Filed: Sep. 20, 2024

(51) Int. Cl. G06F 9/50; G06F 9/455

(52) U.S. Cl. CPC G06F 9/5077; G06F 9/45558; G06F 2009/4557

(57) ABSTRACT

Methods, computer program products, and systems are presented. The method computer program products, and systems can include, for instance: pulling, by a container host computer environment, layer data of container hub stored container layers that define a target container image; and responsively to a determining that a certain layer of the target container image includes a pre-existing container image layer having pre-existing layer data, creating a replicated reference link, wherein the replicated reference link defines a pointer to a particular directory of the container host computer environment.

### BACKGROUND

Embodiments herein relate to container-based virtualization and in particular to computing resource economized container-based virtualization.

One method for virtualization is container-based virtualization in which container virtual machines are deployed.

Container-based virtualization, also called operating system virtualization, is an approach to virtualization in which the virtualization layer runs as an application within an operating system. In this approach, the operating system's kernel can run on a physical computing node with several isolated application environments installed on top of it. The isolated guest application environments are called containers.

Isolation between the containers occurs at multiple resources, such as at the filesystem, the network stack subsystem, and one or more namespaces, but not limited thereto. By sharing the same running kernel and memory space there is virtually no difference between the performance of the “host” operating system and the containers.

A container image is generally understood to be an unchangeable, static file that includes executable code so it can run an isolated process on information technology (IT) infrastructure. The image, arguably the foundation of container technology, can be understood as a special file system. Images can be utilized to provide not various files, including but not limited to, programs, libraries, resources, and configuration files, which are executed by the container. Images can also include configuration parameters (e.g., anonymous volumes, environment variables, users, etc.), which the containers access during runtime.

### SUMMARY

Shortcomings of the prior art are overcome, and additional advantages are provided, through the provision, in one aspect, of a method. The method can include, for example: pulling, by a container host computer environment, layer data of container hub stored container layers that define a target container image, wherein the pulling includes determining that a certain layer of the target container image includes a pre-existing container image layer having pre-existing layer data stored on the container host computer environment, wherein the pre-existing container image layer is a pre-existing container image layer of a pre-existing container image, wherein pre-existing layer data defining the pre-existing container image layer is stored in a particular directory of the container host computer environment, and wherein the target container image includes a base layer differentiated from a base layer of the pre-existing container image; and responsively to the determining that the certain layer of the target container image includes a pre-existing container image layer having pre-existing layer data, creating a replicated reference link, wherein the replicated reference link defines a pointer to the particular directory of the container host computer environment.

In another aspect, a computer program product can be provided. The computer program product can include a computer readable storage medium readable by one or more processing circuit and storing instructions for execution by one or more processor for performing a method. The method can include, for example: pulling, by a container host computer environment, layer data of container hub stored container layers that define a target container image, wherein the pulling includes determining that a certain layer of the target container image includes a pre-existing container image layer having pre-existing layer data stored on the container host computer environment, wherein the pre-existing container image layer is a pre-existing container image layer of a pre-existing container image, wherein pre-existing layer data defining the pre-existing container image layer is stored in a particular directory of the container host computer environment, and wherein the target container image includes a base layer differentiated from a base layer of the pre-existing container image; and responsively to the determining that the certain layer of the target container image includes a pre-existing container image layer having pre-existing layer data, creating a replicated reference link, wherein the replicated reference link defines a pointer to the particular directory of the container host computer environment.

In a further aspect, a system can be provided. The system can include, for example, a memory. In addition, the system can include one or more processor in communication with the memory. Further, the system can include program instructions executable by the one or more processor via the memory to perform a method. The method can include, for example: examining data of breaches of a geofence by client computer devices to determine respective positions of the breaches; establishing an updated location for the geofence using the determined respective positions of the breaches; updating a location of the geofence so that the location of the geofence is the updated location; obtaining data of a client computer breach of the geofence at the updated location; and providing one or more output in response to the obtaining data of a client computer breach of the geofence at the updated location.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a container hub computer environment, a container host computer environment, user equipment (UE) devices, and an application program interface (API) service endpoint according to one embodiment;

FIG. 2A depicts a container host computer environment storing container images having shared layers according to one embodiment;

FIG. 2B depicts a container host computer environment storing container images having shared layers according to one embodiment;

FIG. 3A-3B is a flowchart illustrating a method for performance by a container host computer environment interoperating with a container hub computer environment, and UE devices (and/or one or more API service endpoint) according to one embodiment;

FIG. 4A a data structure depicting container images linked by a replicated reference link according to one embodiment;

FIG. 4B a data structure depicting container images linked by a replicated reference link according to one embodiment;

FIG. 5 depicts a unified file system for a runtime instance of first and second container images according to one embodiment;

FIG. 6 depicts a container host computer environment, by a container virtualization daemon, performing an image pull according to one embodiment;

FIG. 7 depicts a container host computer environment, by a container virtualization daemon, performing an image pull according to one embodiment;

FIG. 8 depicts a container host computer environment, by a container virtualization daemon, performing container image deletion management according to one embodiment;

FIG. 9 depicts a container environment system according to one embodiment;

FIG. 10 depicts a computing environment according to one embodiment.

### DETAILED DESCRIPTION

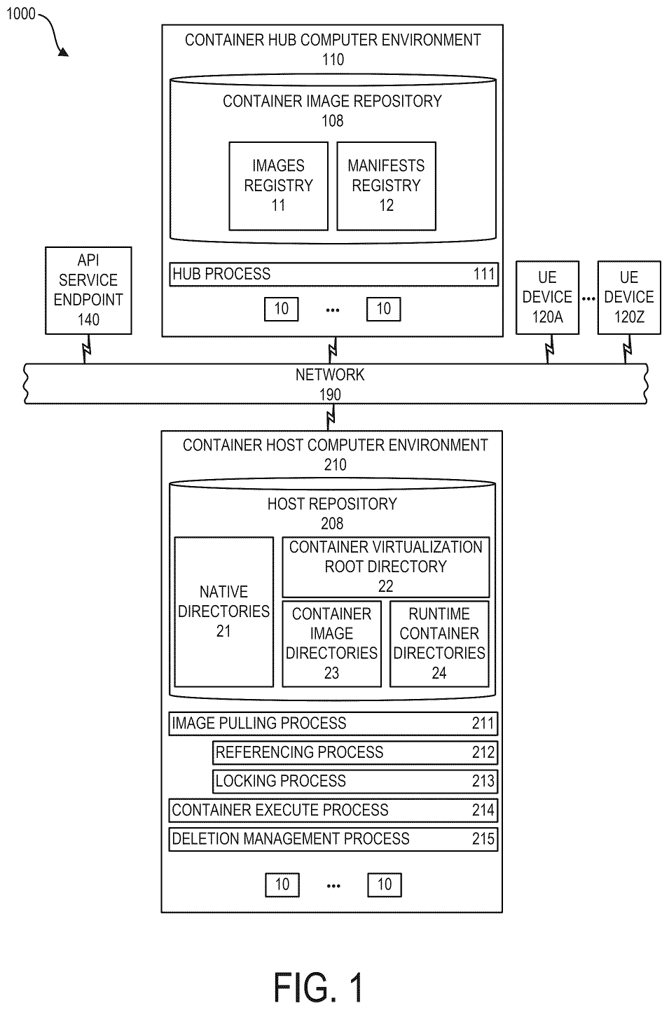

System 1000 for use in resource economized building container images is shown in FIG. 1. System 1000 can include container hub computer environment 110, container host computer environments 210, user equipment (UE) devices 120A-120Z and application program interface (API) service endpoint 140. Container hub computer environment 110, container host computer environment 210, UE devices 120A-120Z, and API service endpoint 140 can be computing node-based systems in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Container hub computer environment 110 can include container image repository 108 that stores container images. Container hub computer environment 110 can be configured for use by container host computer environment 210 which container host computer environment 210 can be associated to a particular enterprise. System 1000 can include multiple instances of container host computer environment 210, each associated to the different enterprise. Container hub computer environment 110 in one aspect can make available various container images for use by respective ones of the container host computer environment 210.

Container host computer environment 210 can be configured to build container images. In building a container image at container host computer environment 210, container host computer environment 210 can pull one or more container image from container hub computer environment 110. In further aspect, container host computer environment 210 can push container images to container hub computer environment 110 for storage therein so that the pushed container images can be accessed for use by instances container host computer environment 210, wherein respective ones of instances of container host computer environment 210 are associated to different enterprises. In one embodiment, container hub computer environment 110, and container host computer environment 210 can be configured in accordance with a commercially available container platform technology. Commercially available container platform technologies include, e.g., DOCKER®, PODMAN®, LXC®, and OPENSHIFT®. DOCKER® is a registered trademark of Docker, Inc., PODMAN® is a registered trademark of Red Hat, Inc., LXC® is a registered trademark of Canonical Ltd., and OPENSHIFT® is a registered trademark of Red Hat, Inc.

UE devices 120A-120Z can be used by various users, i.e., administrator user of system 1000. Administrator users of system 1000 can include agent administrator users of respective vendor enterprises associated to the respective ones of container host computer environment 210. Administrator users can also be, e.g. an administrator user associated to container hub computer environment 110.

Container hub computer environment 110 can include container image repository 108. Container image repository 108 can store in container images registry 11 container images. Each container image can include a lightweight, standalone, executable package that includes everything needed to run a piece of software, such as the code, runtime, libraries, environment variables, and configuration files. Container images are typically built in layers, with each layer representing a change or addition to the image. These layers can be stored in images registry 11 and can be shared across multiple images, optimizing storage and download efficiency.

Container image repository 108 in manifests registry 12 can store, e.g. a manifest associated to respective ones of container images stored in container images registry 11. A container image manifest can include information for assembling and running a container image, including the schema version, media type, and a list of image layers with their digests, media types, and sizes. A container image manifest can include the image configuration with its digest, media type, and size, and can specify the architecture and operating system for which the image is built. Optional sections include the image's history, additional annotations, and platform compatibility details. This comprehensive blueprint ensures the container runtime can correctly reconstruct and execute the container image.

Container hub computer environment 110 can run various processes. Container hub computer environment 110 running hub process 111 can include container hub computer environment 110 performing various functions that define container hub computer environment 110 as a container hub computer environment. Such functions can include, e.g., providing a centralized platform for storing, managing, and distributing container images. Functions defining container hub computer environment 110 as a container hub computer environment can also or alternatively include providing a repository where developers can store their container images. These images are typically built using a predetermined file format and can include all the dependencies and configurations needed to run an application. Functions defining container hub computer environment 110 as a container hub computer environment can also or alternatively include providing public repositories, which are accessible to anyone, or private repositories, which are restricted to specific users or teams. The described flexibility allows for both open source sharing and secure, private storage. supports versioning of container images, allowing developers to tag images with specific versions. This makes it easy to track changes, roll back to previous versions, and maintain a history of image updates. Functions defining container hub computer environment 110 as a container hub computer environment can also or alternatively include automatically building container images from source code repositories like GitHub or Bitbucket. This feature integrates with version control systems to trigger builds whenever code changes are pushed to the repository. Container hub computer environment 110 can be configured to facilitate distribution of container images by providing a centralized location from which users can pull images. This facilitates sharing and collaboration within teams and across organizations. Users can search for and discover container images created by others. Functions defining container hub computer environment 110 as a container hub computer environment 110 can also or alternatively include hosting a wide range of pre-built images for various applications and services, which can be used as starting points for new projects. Functions defining container hub computer environment 110 as a container hub computer environment can also or alternatively include providing security scanning features that analyze container images for known vulnerabilities. This helps ensure that the images being used in production are secure and up to date. Container hub computer environment 110 can be configured to send notifications or trigger webhooks based on events such as new image pushes. This integration can help automate workflows and keep teams informed about changes.

Container hub computer environment 110 can include various computing nodes 10. Computing nodes 10 can be physical computing nodes. Computing nodes 10 can e.g., host one or more database defining, respectively, container images registry 11 and manifests registry 12 of container image repository 108. One or more computing node of computing nodes 10 can also, e.g., host one or more program defining the functions performed by hub process 111. It will be understood that processes herein performed by container hub computer environment 110 can be performed by one or more computing node 10 running one or more program.

Host repository 208 of container host computer environment 210 can include native directories 21, container virtualization root directory 22, container image directories 23 and runtime container directories 24. Container image directories 23 and runtime container directories 24 can be headed under container virtualization root directory 22.

Native directories 21 can include, e.g., a root file system, i.e., a root directory that contains standard directories for the host operating system. Native directories 21 can hold the operating system's binaries, libraries, configuration files, and the like. Native directories 21 can also include, e.g., user specific data, include directories for storing user specific data, and configuration files. Native directories 21 can further include temporary files created by processes running on container host computer environment 210.

In container host computer environment, both container images and runtime containers can be stored under a common root directory, which can be located, in the case of a DOCKER® platform embodiment at /var/lib/docker/, but they can be organized into distinct subdirectories to manage their different types of data. Container images can be stored within a /var/lib/docker/<storage-driver>/directory, where <storage-driver> refers to the specific storage backend container host computer environment 210 can be using, such as overlay2, aufs, or btrfs. The described directory structure can include various subdirectories like diff and metadata that hold the image layers and associated metadata. On the other hand, runtime containers can be stored, in a DOCKER® platform embodiment, under /var/lib/docker/containers/, where each container, whether running or stopped, has its own directory containing essential data like metadata, logs, and the container's writable layer. This separation within the common root directory ensures that container host computer environment 210 efficiently organizes and manages the different types of data associated with images and containers, facilitating the smooth operation and lifecycle management of containers. In a PODMAN® platform embodiment, /var/lib/containers/storage/overlay can define a subdirectory within the storage directory of computer host computer environment 210 that specifically handles image layers (the extracted layers data) and container data using the overlay storage driver, and /var/lib/containers/storage/overlay-containers can define a subdirectory used to store the runtime state of containers that are using the overlay storage driver.

Container image directories 23 can be used to store the static, read-only layers and associated metadata that make up container images. These directories can be located under /var/lib/docker/<storage-driver>/, where <storage-driver> corresponds to the storage backend in use, such as overlay2, aufs, or btrfs. Each layer of an image can be stored in its own subdirectory, identified by unique IDs (hashes), which represent the filesystem changes introduced by that layer, such as added or modified files. The structure also includes metadata that tracks dependencies and the relationships between layers, enabling container host computer environment 210 to efficiently manage and reuse layers across multiple images. Because these image layers are immutable once created, they are read-only and can be shared across multiple containers, which optimizes storage and reduces redundancy. The image directories persist as long as the images exist on the host, unaffected by the lifecycle of containers that may be created from these images.

Runtime container directories 24 can be dedicated to managing the unique, dynamic data associated with each running or stopped container. These directories, in the case of a DOCKER® platform embodiment, located under /var/lib/docker/containers/, with each container having its own directory named after its unique container ID. These directories contain the container's writable layer, where any changes made during the container's runtime—such as file modifications, deletions, or new files—are stored. This writable layer is part of the unified filesystem that container host computer environment 210 creates by overlaying the read-only image layers with this writable layer, providing the container with a seamless, single filesystem view. In addition to the writable layer, runtime container directories also store container-specific logs, metadata, and configuration files, which are essential for managing the container's state, networking, and resource usage. Unlike image directories, runtime container directories are read-write and are unique to each container, ensuring data isolation between containers. These directories exist only for the lifespan of the container; when the container is deleted, its directory and all associated data are removed.

Container host computing environment 210 performing image pulling process 211 can include a container host computer environment pulling a container image from a registry like Docker Hub, it begins by resolving the image name and retrieving the image manifest, which lists the image's layers and their corresponding digests. In one embodiment, a container virtualization daemon can checks whether any of these layers are already stored locally to avoid redundant downloads. For layers that are missing, the daemon can request and downloads them from the registry. Each layer can be compressed during transmission to save bandwidth. Once a layer is downloaded, container host computer environment 210, in a DOCKER® container platform embodiment, can decompress and store the layer in a storage directory of container image directories 23 under /var/lib/docker/<storage-driver>/. Each layer can be stored in its own unique subdirectory, often referred to as a ‘diff’ directory. These directories can be named after the layer's digest, which is a cryptographic hash that uniquely identifies the content of that layer. The diff directory can contain the specific filesystem changes that this layer introduces, such as added or modified files. As container host computing environment 210 pulls each layer, it verifies its integrity by checking the digest against the value provided in the manifest, ensuring the layer is intact and untampered. This structure allows container host computing environment 210 to efficiently manage the layers, enabling layer reuse across multiple images and containers by sharing these “diff” directories. After all layers are downloaded, verified, and stored in their respective diff directories, the described container virtualization daemon can compile the necessary metadata, including the image configuration and the manifest, into the local container host repository 108. The image can then be tagged according to the user's command, making it easily accessible for creating containers. This detailed organization of layers into separate diff directories not only optimizes storage efficiency but also facilitates quick access and reuse of image layers, ensuring that container host computing environment 210 can efficiently manage images and containers. Container host computing environment 210 performing image pulling process 211 can include container host computer environment 210 performing referencing process 212 and locking process 213.

Container host computer environment 210 running referencing process 212 can include container host computer environment 210, in performing an image pull, generating a diff replicated reference link (DRRL) when determining a layer pulled for storage into container host computer environment 210 is a replicate layer of a previously stored layer. On determining that layer for download is a replicated layer, container host computer environment 210 can generate a diff replicated reference link (DRRL) that provides a pointer to previously stored replicated layer.

Container host computer environment 210 running locking process 213 can include container host computer environment 210, in performing an image pull, generating an attribute to conditionally lock and restrict a shared layer from being deleted when determining a layer pulled for storage into container host computer environment 210 is a replicate layer of a previously stored layer. Embodiments herein recognize that, according to the state of the art, when first and second container images are based on a different base layer include a replicated layer between the images, the replicated layer will be extracted twice locally on container host computer environment. Embodiments herein provide a method for referencing replicate layers within images that are based on different base images base layers. Accordingly, replicate layer data can be extracted only once locally and multiple extractions of a replicated layer can be avoided for economization of computing resources including storage resources.

Container host computer environment 210 running container execute process 214 can include container host computer environment 210 executing a runtime instance of a container image. Container host computer environment 210 running container execute process 211 can include container host computer environment 210 providing various runtime environments for support of containers managing their lifecycle including starting, stopping, and restarting. When container host computer environment 210 executes a container, it begins by ensuring that all necessary image layers are available locally, each stored in distinct “diff” directories under the container host computer environment 210 storage directory, typically at /var/lib/docker/<storage-driver>/. These layers represent incremental changes to the filesystem, such as added or modified files, and are stacked in the correct order to form a complete, unified filesystem. Container host computer environment 210, in one embodiment, can employ a union filesystem, such as OverlayFS, to combine these read-only layers, placing the oldest layer at the bottom and the newest at the top. On top of these stacked layers, container host computer environment 210 can add a writable layer that is unique to the container, allowing any changes made during runtime—such as file modifications, log writing, or temporary data storage—to be captured without altering the original image layers. The described process ensures that the same image can be reused for multiple containers while keeping their runtime changes isolated.

Container host computer environment 210 running container execute process 214 can include container host computer environment 210 setting up the container's environment by configuring Linux namespaces and control groups (cgroups) to provide process and resource isolation. Namespaces ensure that the container has its own isolated view of system resources like process IDs, network interfaces, and filesystems, while cgroups manage the container's resource usage, including CPU, memory, and I/O. Container host computer environment 210 can also configures the container's networking, assigning an IP address and setting up network interfaces according to the specified network mode (e.g., bridge, host, or overlay). Once the environment is set, container host computer environment 210 can initiate the container by executing the entrypoint or command defined in the Dockerfile or specified by the user at runtime. This command runs in the context of the container's isolated filesystem and environment. The container's main process runs with PID 1 inside its own process namespace, meaning it is fully isolated from the host's process tree. Throughout the container's lifecycle, any file operations are directed to the writable layer, ensuring that changes are container-specific and that the underlying image remains untouched.

If the container's main process terminates, container host computer environment 210 running container execute process 211 can include container host computer environment 210 stopping the container, marking the end of its runtime. The writable layer and all associated container-specific metadata can be preserved until the container is explicitly removed, allowing users to inspect logs or data. When the container is removed, container host computer environment 210 can clean up the writable layer and other resources, but the original image layers can be retained for future use, allowing for efficient reuse of the image across multiple containers. Container host computer environment 210 running container execute process 211 can include container host computer environment using a replicated reference link in accessing layer data of the layer during the executing of a runtime instance of a container image. In one embodiment, a layer directory of a second image having a certain layer in common with a particular layer of first container image can store a replicated layer link referencing the certain layer. When a container host computer environment executes a runtime instance of the second image, running of the runtime instance can include reading data of the certain layer and being redirected to a directory of the particular layer.

Container host computer environment 210 running deletion management process 215 can include container host computer environment 210 restricting or qualifying a source container image layer for deletion. Container host computer environment 210 running deletion management process 215 can include container host computer environment 210 receiving a request to delete the pre-existing container image layer, determining, responsively to the receiving the request to delete the pre-existing container image layer, that there is one or more active replicated reference link defining a pointer to the pre-existing container image layer, and restricting deletion of the pre-existing container image layer responsively to the determining that there is one or more active replicated reference link defining a pointer to the pre-existing container image layer. Container host computer environment 210 running deletion management process 215 can include container host computer environment 210 receiving a request to delete the pre-existing container image layer, discovering, responsively to the receiving the request to delete the pre-existing container image layer, that there is no active replicated reference link defining a pointer to the pre-existing container image layer, qualifying the pre-existing container image layer for deletion responsively to the discovering that there is no active replicated reference link defining a pointer to the pre-existing container image layer, and deleting the pre-existing container image layer responsively to the qualifying.

Embodiments herein provide an intelligent and convenient method to reference replicate layers. Embodiments herein enable users to store only necessary layers from various images, even when they originate from different base layers. Embodiments herein can significantly optimize local storage utilization, especially when managing images for multiple products including when managing images for multiple products.

Container host computer environment 210 can include various computing nodes 10. Computing nodes 10 can be physical computing nodes. Computing nodes 10 can e.g., host one or more database defining host repository 208. One or more computing node of computing nodes 10 can also e.g., host one or more program defining the functions performed by processes 211-215. It will be understood that processes herein performed by container host computer environment 210 can be performed by one or more computing node 10 running one or more program.

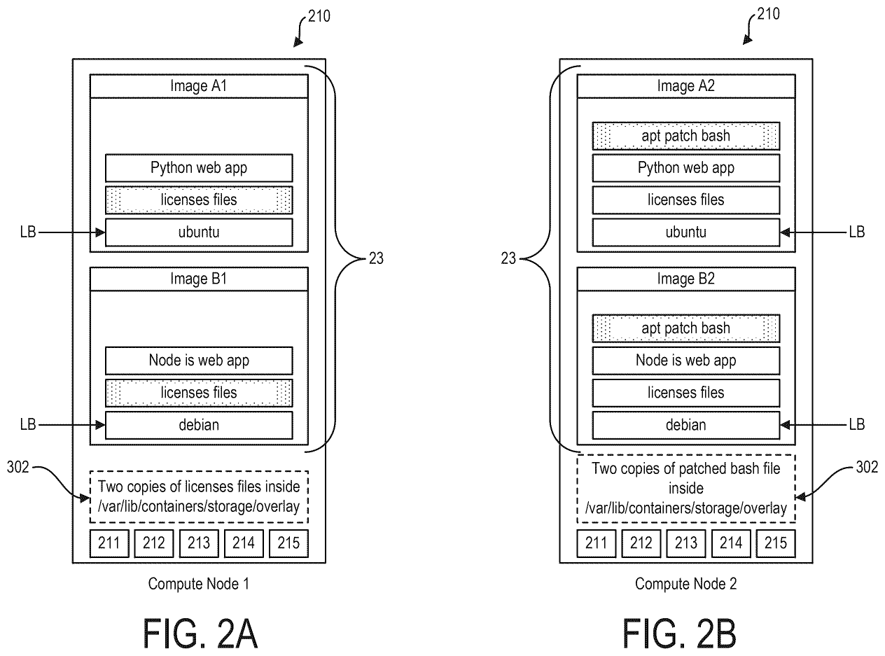

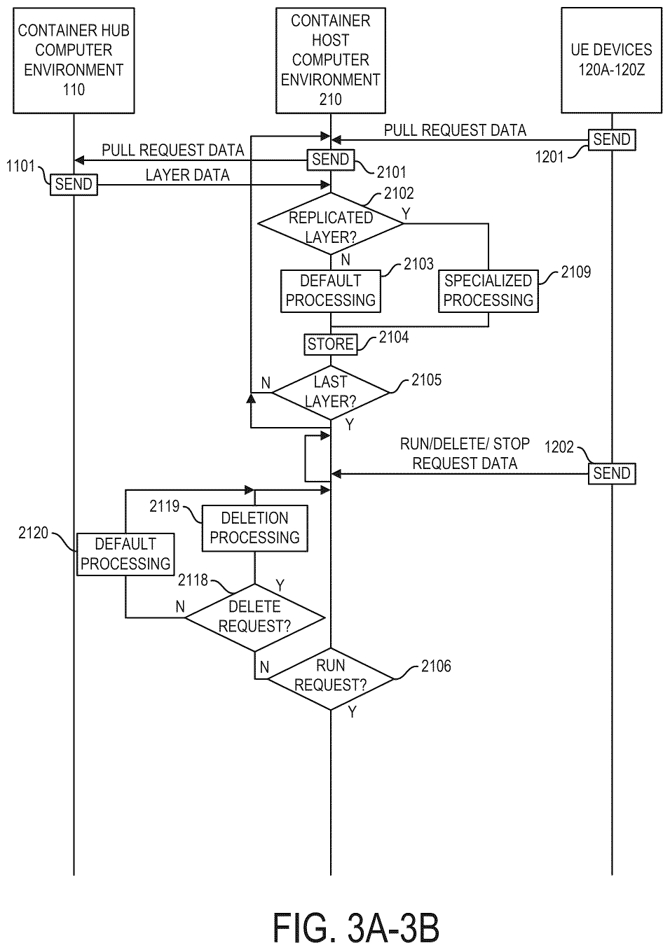

In FIGS. 2A and 2B there is depicted a representation of container host computer environment 210 storing container images in container image directories 23. In the embodiment of FIG. 2A, container image directories 23 store container image A1 and container image B1 having differentiated base layers LB. In the embodiment of FIG. 2B, container image directories 23 store container image A1 and container image B1 having differentiated base layers LB. Embodiments herein recognize that, according to the state of the art, when first and second container images are based on a different base layer include a replicated layer between the images, the replicated layer will be extracted twice locally on container host computer environment as depicted with reference to dashed area 302. Embodiments herein provide a method for referencing replicate layers within images that are based on different base images base layers. With use of various processes such as processes 211-215 set forth in reference to FIG. 1, replicate layer data can be extracted only once locally for economization of computing resources.

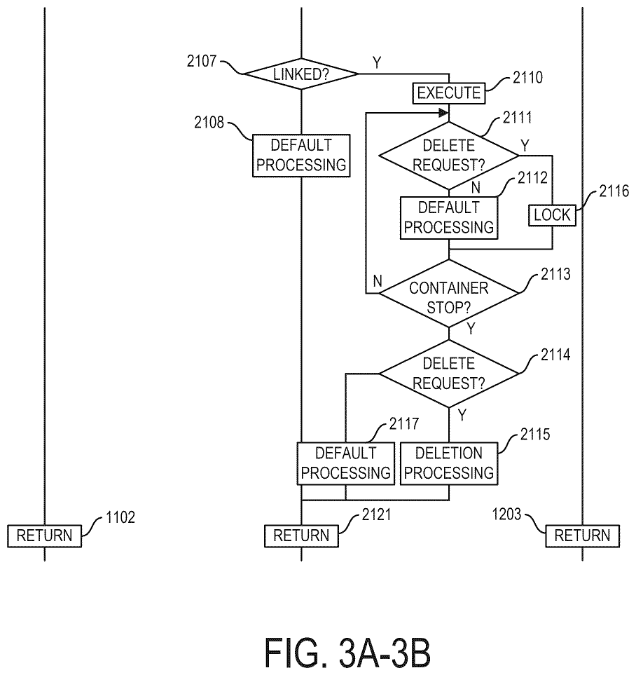

A method for performance by container host computer environment 210 interoperating with container hub computer environment 110 and UE devices 120A-120Z is set forth in reference to the flowchart of FIGS. 3A-3B.

At block 1201, a UE device of UE devices 120A-120Z, e.g., based on input of an administrator user can send pull request data for receipt by container host computer environment 210.

In response to the receipt pull request data, container host computer environment 210 can send pull request data to container hub computer environment 110 at send block 2101. Once the response has been received, container hub computer environment 110 at send block 1101 can send layer data for receipt by container host computer environment 210.

For performance of layer pulling set forth in reference to send block 2101 and send block 1101, container host computer environment 210 can fetch an image manifest from manifests registry 22 of container hub computer environment 110 and can download a compressed layer and can verify checksums. In response to the received layer data sent at send block 1101, container host computer environment 210 can proceed to replicated layer decision block 2102.

At replicated layer decision block 2102, container host computer environment 210 can ascertain whether a received layer of a container image being pulled is a replicate of a previously stored layer previously in container directories in a directory of container image directories 23 of container host computer environment 210. Where it is determined at decision block 2102 that the layer is not a replicate layer of a previously stored layer, container host computer environment 210 can proceed to default processing 2103. At replicated layer decision block 2102, container host computer environment 210 can examine container images stored in container image directories 23. In Docker, assigned layer IDs can include ImageID, CacheID, DiffID, ChainID. For examining ImageID, CacheID, DiffID, and ChainID container host computer environment 210 can employ the ‘inspect’ command, which provides detailed metadata about images, containers, and layers. In one embodiment, container host computer environment 210 can run an ‘inspect’ command, e.g., ‘inspect <image_name_or_id>’, to return a JSON output where the Id field represents the unique ImageID. To inspect the CacheID, which is used for caching layers during builds, container host computer environment 210 can examine the output of a build command for observation of which layers are being retrieved from the cache. Container host computer environment 210 can also or alternatively explore Docker's local cache under /var/lib/docker/<storage-driver>/(e.g., overlay2) to identify cached layers. For Diff_ID, which tracks the differences between layers, container host computer environment can use Docker ‘inspect’<image_or_container_id> for return of the RootFS field, where the Layers array contains the DiffID values for each image layer as a series of sha256 hashes. These identifiers correspond to directories in a storage backend that hold the actual filesystem diffs for each layer. Container host computer environment can return data on ChainID, with use of the ‘inspect’ command, specifically within the GraphDriver section, where the LowerDir represents the chain of lower layers and UpperDir represents the topmost layer. The ChainID can be defined by a hash of all layers in the chain, and the data stored in the /var/lib/docker/overlay2/ directory (or similar depending on the storage driver) maps directly to these hashes, representing the full history of image layers.

In the case at decision block 2102 that container host computer environment 210 determines that a currently fetched layer is in fact the replicate of a previously stored layer, container host computer environment 210 can proceed to specialized processing block 2109. In determining that currently fetched layer is a replicate of a previously stored layer, container host computer environment 210 can determine that the previously stored layer is a previously stored layer of a previously stored container image having a base layer differentiated from a base layer of the target container image of the current image pull. The base layer can define the foundational layer of a container image, upon which all other layers are built. It typically consists of a minimal operating system or runtime environment that provides the necessary libraries and binaries to support the application or services defined in a container build file. The base layer is immutable and serves as the starting point for building the additional layers that contain the specific dependencies, configurations, and application code needed for the final container image. Each subsequent layer adds or modifies files on top of this base layer, creating the complete image.

At specialized processing block 2109, container host computer environment 210 can perform specialized processing. The specialized processing performed at specialized processing block 2109 can include processing to establish a reference to the previously stored layer data of the identified replicate layer previously stored in a directory of container image directories 22.

In one embodiment, container host computer environment 210 at specialized processing block 2109 can generate, within a container image layer directory for the currently pulled image, a diff replicated reference link (DRRL) to a previously existing diff directory of container image directories 22, wherein the replicated reference link points to the diff directory at which the layer data of the identified replicated layer identified at replicated layer decision block 2102 has been stored. For performance of block 2109, container host computer environment 210 can write the described replicated reference link to the layer directory of the target layer being pulled determined at block 2102 to be a replicated layer of a previously stored image. The DRRL defines a pointer to the layer directory of the prior stored replicated container image layer determined to be replicated at decision block 2102.

Further at specialized processing block 2109, container host computer environment 210 can update the previously existing diff directory for the pre-existing replicated layer determined to be replicated at decision block 2102 with an attribute which can be referred to as ‘diff shared lock’. The diff shared lock attribute created at specialized processing block 2109 can prevent the previously stored source layer from being deleted absent one or more specified condition being satisfied. Embodiments herein recognize that processing can benefit from a feature wherein deletion of a previously stored source layer is locked and prevented where a replicated reference link to the previously stored layer has been created and is in use by system 1000. A deletion lock feature herein can prevent deletion of a source layer, so that subsequent layers that are replications of the source layer and which are defined by links to source layer can continue to operate. Container host computer environment 210 at specialize processing block 2109 can write attribute information defining the locking attribute to the layer directory of the prior stored replicated container image layer determined to be replicated at decision block 2102.

Further at specialized processing block 2109, container host computer environment 210 can update shared layer status metadata that specifies a status of layers that are shared between container images stored in container image directories. Shared layer status metadata can be stored, e.g., within container virtualization root directory 22 or in another directory of host repository 208. An example of shared layer status metadata is set forth in reference to Table A.

```
TABLE A
{
  “diff-digest”: “sha256:994393dc58e7931862558d06e46aa2bb17487044f670f310dffeld24e4dleec7”,
  “reference-count”: 2,
  “source-cacheid”: “fc24c7823f79827753fcebeb2f5fcdfa8396e69220635816b061e5288a17eebf”,
  “source-repository”: “docker/test0-image:1.0”,
  “replicate-cacheids”: {
    “harbor/test2-image:0.1”:
“5d9bf215ca94e8a2b8624b74b5352d1d8cb50612876a3a4faf47b6cff6c470a2”,
    “quay/test3-image:2.0”:
“ab9f1c6d7d156ebbb5b4e00d4ceed4a51d7e9cdOce2bOla15456af316e01c9f5”
  },
  “diff-digest”: “sha256:5074974374bcef7bb6df4e9806c7b291fa13037bd6a732103410dbad7043d6a6”,
  ?
}
```

Further shared layer status metadata is set forth in reference to Table B.

TABLE B

| | Active linked layers linked |
|---|---|
| Source layer ID | to the source layer |
| ‘sha256:3b2c3f707e5361549ff6e2d476edb624b84853eae60baf9d467b7ab31c5cfd74’ | 5 |
| ‘sha256:9e42c53a8c41d9c19fcfc24c7e178a5d6a02a276476f805515437a38f1aaecaf’ | 0 |
| ‘sha256:2d3b1bdb1a5c15d616b0381c61648e650d1cc7c8c5e0dbb72a28a9efdf2f9d0d’ | 1 |
| . . . | . . . |

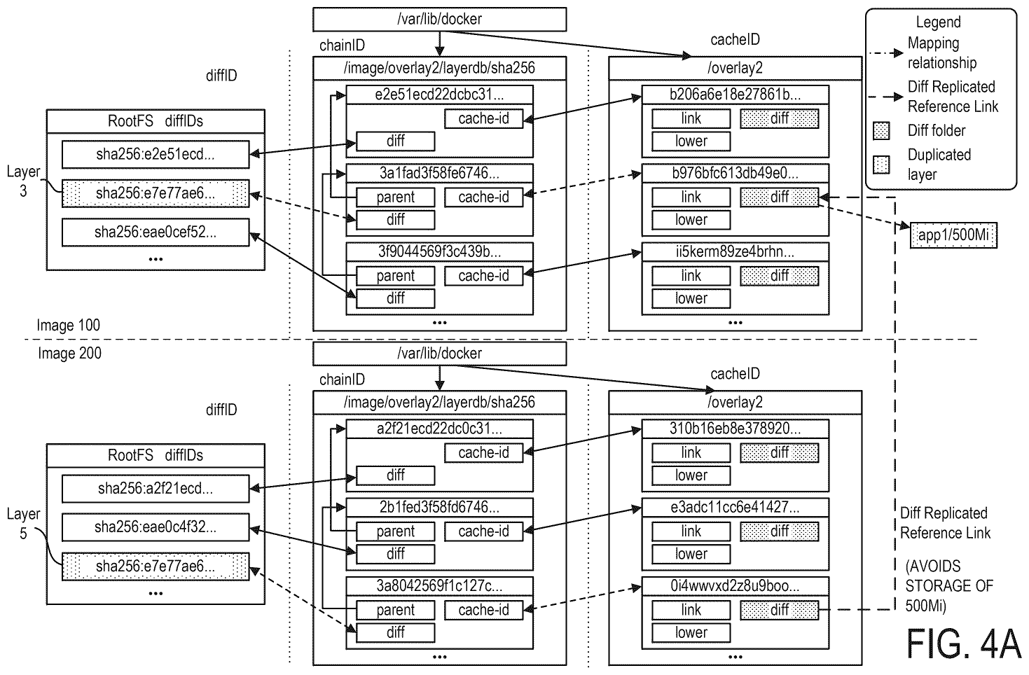

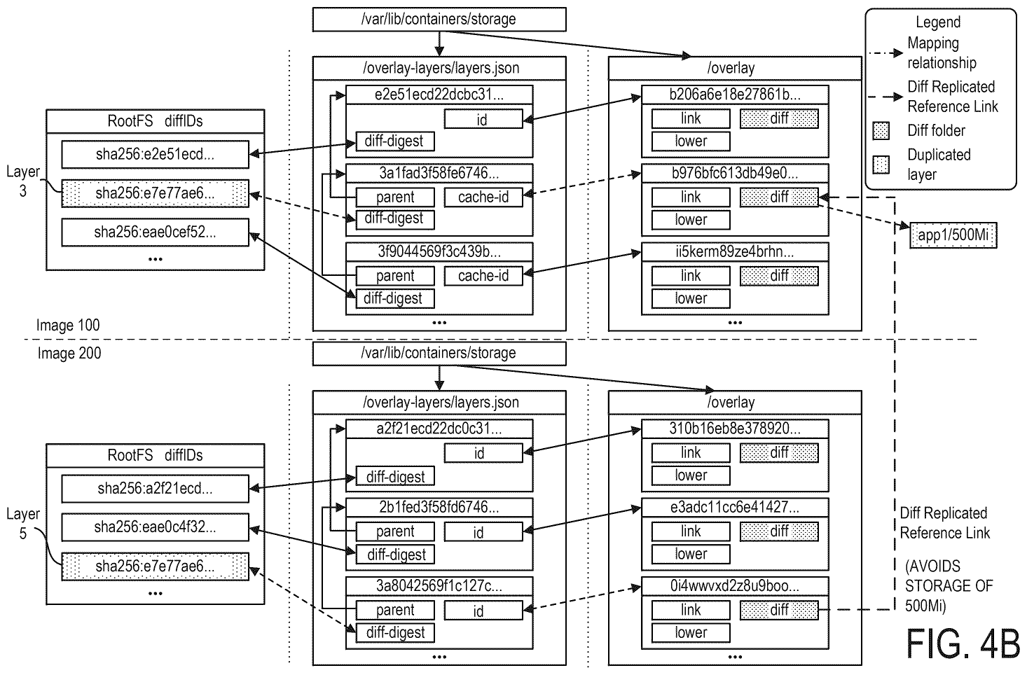

The shared layer status metadata of Table A and Table B specifies shared source layers that have been identified by container host environment 210, and a counter that specifies a count of active linked layers that are linked to each identified source layer. A shared (replicated) container image layers herein can include a source shared container image layer and one or more linked container image layer. The source container image layer can be the initially stored container image layer, e.g., the shared layer 3 container image 100 depicted in FIGS. 4A and 4B herein, and the one or more linked container image layer herein can refer to a layer that is linked to the source layer by a diff replicated reference link (DRRL) as set forth herein that defines a pointer to the source shared container image layer. Container host computer environment 210 can update the described shared layer status metadata, e.g., at specialized processing block 2109 when pulling an image and identifying a shared and replicated layer, and on deletion of shared layer, as set forth in greater detail herein.

With the performance of default processing 2103 or alternatively specialized processing 2109, various layer data can be stored in appropriate directories of container image directories 22 as is indicated by store block 2104.

When a container image is pulled from container image repository 108 of container hub computer environment 110, the container image can be composed of multiple layers, each representing different stages of the container image's creation. Container host computer environment 210 can check if any of these layers already exist locally and only downloads the missing ones. The layers can be stored on container host computer environment 210 under /var/lib/docker/in a structure managed by the storage driver (e.g., Overlay2). Each layer can include a directory containing files specific to that stage of the image build. Where a certain layer of a target container image being pulled is identified at block 2102 as having a previously stored replicate layer with layer data stored in a particular directory of container image directories 23, container host computer environment 210 can generate and store in a certain directory of the container image directories 22 for the certain layer a replicated reference link that defines a pointer to the particular directory.

In one embodiment, each layer of a container image can be stored in its own directory of container image directories 23, e.g., under /var/lib/docker/overlay2/. These directories can contain the filesystem changes for that layer, identified by unique hashes. Container host computer environment 210 can use these individual layer directories to efficiently manage and overlay the layers, forming the complete filesystem for containers, allowing for reuse and sharing of layers across different images.

In container image directories 23, the different directories that store individual layers can be referred to as “diff” directories. In one aspect, each “diff” directory can contain the differences or changes that a specific layer introduces to the filesystem, such as added, modified, or deleted files. These “diff” directories are part of the overall structure that container host computer environment 210 can use to manage the layers of a container image, allowing it to efficiently apply these changes when constructing the unified filesystem for a running container. The term “diff” reflects the fact that each layer represents a differential change from the layer below it.

On completion of store block 2104, container host computer environment 210 can proceed to last layer decision block 2105. At last layer decision block 2105, container host computer environment 210 can ascertain whether the previously stored layer data is of the last layer of a container image for download being pulled during a current container image pull.

On the determination at last layer decision block 2105 that the currently stored layer is not the last layer, container host computer environment 210 can return to stage preceding block 2101 to continue to send pull request data at send block 2101 and to continue to receive new layer data as indicated by send block 1101. Container host computer environment 210 can iteratively perform the loop of blocks 2101 to 2105 until a time on determination at block 2105 data last layer of a requested container image has been downloaded to container image directories 22.

When the current layer is the last layer of the current container image being downloaded, container host computer environment 210 can proceed to run request decision block 2106. At run request decision block 2106, container host computer environment 210 can ascertain whether a container run request has been received. In some scenarios, a container image pull request sent at block 1201 can be defined by a container run command. In such an embodiment, container host computer environment 210 can perform image pulling as part of running a container. Where a container image pull request sent at block 1201 is defined by a container run command, the container run command will be active at the completion of block 2105.

At send block 1202, a UE device of UE devices 120A-120Z can be sending one or more of run/delete, container run, container delete, and/or container stop request data to container host computer environment 210 and at decision block 2106, container host computer environment 210 can ascertain whether the received request data is included to run request data. In another example, container run request data can be sent at block 1201 which container request data can include pull request data indicated as being sent at block 1201. In another example, pull request data can be sent at block 1202 without container run request data being sent.

Turning again to run request decision block 2106, container host computer environment 210 at run request decision block 2106 can ascertain whether request to run a stored container image has been received. On the determination at block 2106 that a run request has not been received, container host computer environment 210 can proceed to decision block 2118 to ascertain whether a container image deletion request is active and if so can proceed to block 2119 to perform specialized deletion processing to selectively and conditionally delete layer data previously established for various one or more container image at specialized processing block 2109. On the determination at block 2118 that no delete request is active, container host computer environment 210 can perform default processing at block 2120. On completion of deletion processing at block 2119 or default processing at block 2119, container host computer environment 210 can return to block 2106 to ascertain whether a run request has been received and can iteratively perform the loop of block 2106, 2118, 2119 (2120) until a time at block 2106 it is determined that the request to run a stored container image has been received.

On the determination at decision block 2106 that a request to run stored container image has been received, container host computer environment 210 can proceed to linked decision block 2107.

At linked layer decision block 2107, container host computer environment 210 can ascertain whether the container image for which a run request has been received is a linked container image having a linked layer that was subject to processing by specialized processing block 2109. On determination that the container image for which a run request was received was subject of specialized processing at block 2109, container host computer environment 210 can proceed to execute block 2110. A linked layer herein can refer to a layer that is linked to a source layer by a replicated reference link herein.

At execute block 2110, container host computer environment 210 can execute a runtime instance of a container image in accordance with specialized processing in which a replicated reference link is utilized for running a container, which replicated reference link was established at specialized processing block 2109.

FIG. 4A depicts a filesystem view of image 200 and image 100, where image 200 includes a layer replicated from image 100, namely layer 5 in image 200 is a replicate of layer 3 in image 100. As indicated in FIG. 4A and as described in reference to specialized processing block 2109, a diff directory for layer 5 of image 200 includes a replicated reference link to layer 3 of image 100. At execute block 2110 container host computer environment 210 can use the described replicated reference link of FIG. 4A for executing a runtime container.

In further reference to FIG. 4A, diffID refs to a unique identifier that represents the specific changes a layer introduces to the filesystem, generated as a digest of the uncompressed layer's content. This allows container host computer environment 210 to precisely identify the filesystem modifications made by each layer. The identifier chainID is a unique identifier that tracks the entire sequence of layers leading up to and including a particular layer, calculated by hashing the chainID of the previous layer with the diffID of the current layer. This ensures that container host computer environment 210 to can accurately manage and verify the integrity and order of layers, facilitating efficient layer reuse across different images. The identifier cacheID is an identifier used during the container image build process to determine if a layer can be reused from the build cache, based on whether the build context and instructions have remained unchanged.

For executing a runtime instance of a container image at execute block 2110, container host computer environment 110 can create a unified filesystem for the container by combining the read-only layers from the image with a new, writable layer. This unified filesystem can be presented to the container as its root filesystem. For executing a runtime instance of a container image, container host computer environment 210 can create, e.g., a ‘merged/’ directory within runtime container directories which represents the unified, merged view of the container's entire filesystem at runtime, and can create a ‘work/’ directory within directories 24 used by, e.g., the overlay filesystem OverlayFS in one embodiment to facilitate merging of layers and to store temporary data during the container's runtime

Once the container is running, all file operations (reading, writing, modifying) can be performed within the described unified filesystem. The read-only layers from the container image do not change and are not modified during runtime. Instead, any changes made by the container, such as creating or modifying files, occur in the writable layer. This writable layer is specific to that container instance. In the case of unified file system for running of an instance of a container image having a layer subject to specialized processing at block 2109, the read-only layer directories of the read-only layers can include a read-only directory having a replicated reference link as set forth in reference to block 2109, which replicated reference link defines a pointer to a layer directory of another container image.

The image layers and the writable layer can be managed by the container runtime, typically within a specific directory structure on the host filesystem (e.g., /var/lib/docker on container host computer environment 210). In one embodiment, the container image itself isn't “copied” to a new directory but rather mounted and used in the location managed by the runtime. In summary, the container image is not copied into a new directory when a container is started. In one embodiment, the container image stored and managed by the container runtime in a structured way that allows for efficient reuse and layering.

During the runtime of a container, the read-only image data from the image layers may be required in various scenarios. During the runtime of a container, the container can access read-only image layers whenever it needs to retrieve files, executables, or resources that were included in the original container image, such as binaries, libraries, or configuration files. These read-only layers are managed by the container runtime through an overlay filesystem, like OverlayFS, which stacks the layers in a specific order and combines them with a writable layer unique to the running container.

When a process inside the container reads a file, the overlay filesystem first checks the writable layer for any modifications or additions; if the file is not found there, it then accesses the necessary data from the underlying read-only image layers. This approach ensures efficiency by allowing multiple containers to share the same read-only layers without replicating them, which reduces disk space usage and load times. Additionally, the use of a “copy-on-write” mechanism ensures that any modifications to files in the read-only layers result in copies being made to the writable layer, preserving the immutability of the original image and maintaining a consistent base environment across different container instances.

In the case a unified file system for a runtime container includes a read-only directory having the described replicated reference link, access to underlying container image data can be provided via the replicated reference link. In reading layer data for layer 5 of image 200 in the described embodiment of FIG. 4A, container host computer environment 210 can be redirected by the described replicated reference link to the layer data of layer 3 of container image 100. There is set forth herein, in one embodiment, pulling by a container host computer environment 210, layer data of container hub, e.g., container hub computer environment 110, stored container layers that define a target container image, wherein the pulling includes determining that a certain layer of the target container image includes a pre-existing container image layer having pre-existing layer data stored on the container host computer environment, wherein the pre-existing container image layer is a pre-existing container image layer of a pre-existing container image, wherein pre-existing layer data defining the pre-existing container image layer is stored in a particular directory of the container host computer environment, and wherein the target container image includes a base layer differentiated from a base layer of the pre-existing container image; and responsively to the determining that the certain layer of the target container image includes a pre-existing container image layer having pre-existing layer data, creating a replicated reference link, wherein the replicated reference link defines a pointer to the particular directory of the container host computer environment, and wherein the method includes executing a runtime instance of the target container image subsequent to the pulling, wherein the executing the runtime instance of the target container image subsequent to the pulling includes accessing data of the pre-existing layer data stored within the particular directory using the replicated reference link. FIG. 4A depicts a file system view of an embodiment in a DOCKER® container platform. A file system view of an embodiment in a PODMAN® container platform is depicted in FIG. 4B.

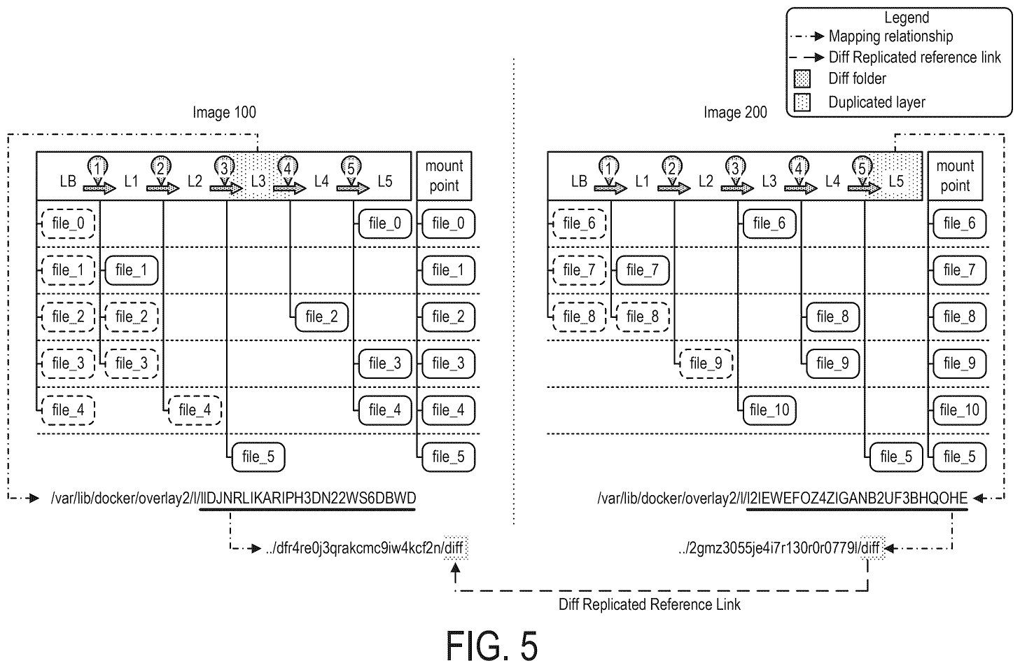

FIG. 5 depicts a unified file system for a runtime instance of container image 100 and a unified file system for runtime instance of container image 200. In container host computer environment 210 as set forth herein, the unified file system for a container can be managed using a union file system like OverlayFS, which combines multiple layers into a single view. This unified file system can be mounted on a computing node 10 of container host computer environment 210 under /var/lib/docker/overlay2/<container-id>/merged, and within the running container, it appears as the root directory (/). This setup allows the container to interact with a combined, layered file system, with the uppermost layer being writable and the underlying layers read-only.

In one aspect, different containers running on container host computer environment 210 can have separate mount points for their file systems, each located in a unique directory under /var/lib/docker/overlay2/. While containers may share some base image layers, their unified file systems, including writable layers, can be isolated and mounted in distinct merged directories specific to each container's ID. The described configuration can ensure filesystem isolation between containers, so changes in one do not affect others.

FIG. 5 depicts mount points for various files. In container host computer environment 210 a mount point allows containers to access and interact with external storage or host directories, enabling data persistence, sharing, and enhanced performance. By creating mount points using volumes, bind mounts, or tmpfs mounts, containers can persist data beyond their lifecycle, share data between multiple containers, or directly access files on the host system, such as configuration files. Volumes, managed by container host computer environment 210, are ideal for persistent storage as they are independent of the host's filesystem and easier to manage, while bind mounts offer direct control over host directories. Additionally, tmpfs mounts improve performance by storing data in memory for temporary use. Mount points also enhance security by allowing precise control over read-only or read-write access to files and directories, ensuring isolated work environments where containers can access necessary data without compromising security or consistency.

FIG. 5 depicts bind mounts. A bind mount in container host computer environment 210 is a type of mount that directly maps a file or directory from the host system into a container, allowing the container to access and interact with the host's filesystem as if it were part of the container's own file structure. Unlike volumes, bind mounts depend on the existing paths on the host, offering flexibility for scenarios like sharing configuration files, source code, or other data between the host and container. This makes them particularly useful in development environments where changes on the host need to be immediately reflected within the container.

FIG. 5 depicts a unified file system for a runtime instance of container image 100 and a unified files system for a runtime instance of container image 200. FIG. 5 depicts a mount point for various container image layers. The mount point of a container image refers to a directory inside the container where a volume is mounted from a host system. The mount point allows the container to access and use the data stored on the file system of container host computer environment 210.

As referred to in FIG. 5, a mount point can define a bridge between a container's file system and host file system. In one aspect, containers are ephemeral in design, meaning their data is lost when a container is stopped or removed. By mounting a directory from a host system onto the container, data can be persisted across container restarts. For example, if a container writes logs or database data to a mounted directory, that data will remain on the host even after the container is destroyed. In another aspect, mount points allow multiple containers to share the same data. By mounting the same host directory under different containers, those different containers can access and modify the same set of files.

Such mounting is useful for various processing like sharing configuration files, logs, or databases between containers. Containers can employ mount points to access resources on a host machine, such as hardware device or other special files.

In a further aspect, a container can be built from the base image, which can be composed of one or more read-only layers. These read-only layers include the operating system, application binaries, libraries and any other dependencies needed by the container. Base image layers can be shared across all containers created from the same image which helps save space and speeds up the container creation. When a container is run, new writable layer can be added on top of the read-only layers from the image. This writable layer is unique to the running container and stores any changes made to the file system during the container's lifetime.

In one aspect, a container's filesystem can be managed using a union filesystem such as OverlayFS, which allows the read-only image layers and the writable container layer to appear as a single cohesive file system. Each time a container is run, even if it's from a same container image, a new writable layer is created providing isolation between containers. For persisting data beyond the lifecycle of a container, a volume or bind mount can be created. In one aspect, container data created during a lifetime of a container can be written to a mounted directory from a host file system in order to bypass the ephemeral nature of a container's writable layer. In one aspect, when a container is started and run, its filing system can be constructed using a union filesystem. This involves layering the read-only image layers and adding a writable layer on top. This combined file system can then be made available to the containers processes.

The mount point for a container can be provided by a directory. When setting up a mount point, whether using a bind mount or a volume, a directory from container host computer environment 210 can be mapped into a directory within the container's filesystem. This directory can serve as the access point for the container to interact with files and subdirectories from the host or a managed storage location. In the case of bind mounts, a specific host directory can be mounted directly into the container, while volumes involve creating and managing the directory that is then mounted. In both scenarios, the mount point can provide a directory that allows the container to seamlessly access and manipulate files as part of its operational environment.

FIG. 5 depicts a unified file system for runtime instance of container image 100 and a unified file system for runtime instance of container image 200. The unified file system for a runtime instance of container image 100 can include read-only directories for layers LB-L5 of container image 100, and the unified file system for a runtime instance of container image 200 can include read-only directories for layers LB-L5 of container image 200.

In the described scenario layer L3 of container image 100 can be replicated as layer L5 of container imager 200. When the runtime instances of container image 100 and container image 200 are created, the unified file systems between the runtime instances can be differentiated. The unified file system for the runtime instance of container image 100 can be absent of any replicated reference link. The unified file system for the runtime container image 200 can include in the read-only directory for container image layer L5 a replicated reference link that defines a pointer for the read-only directory for container image layer L3 for container image 100.

During execution of a runtime instance of a container image running on container host computer environment 210, the container may need to access read-only data stored in its image layers, such as binaries, libraries, scripts, configuration files, or other resources that are essential for the application to function. These accesses occur when the container's processes read files or execute commands that are part of the base image or other read-only layers. The unified filesystem presented to the container is constructed by overlaying these read-only layers with a writable layer, allowing the container to interact with all the necessary files as if they were part of a single, cohesive filesystem.

This unified view is created through mount points managed by a container virtualization daemon when the container starts, ensuring that all required layers are correctly mounted and accessible. While the container virtualization daemon is responsible for setting up the environment and managing these mount points, the actual access to the read-only data during the container's runtime is driven by the containerized application itself, not by the container virtualization client or the daemon.

In one aspect, a container virtualization client is primarily involved in the initial command issuance, such as starting the container, but once the container is running, the processes within the container autonomously access the necessary files from the read-only layers as dictated by the application's operations. This setup ensures that the container can efficiently and securely utilize the data packaged in its image layers while maintaining the isolation and integrity of the underlying filesystem.

At execute block 2110, a runtime instance of container image 200 can be executing with use of the established replicated reference link established at block 2109. In the executing of the runtime instance of the container image 200, the runtime container may access underlying container layer data of container image 200. For example, the runtime container of container image 200 may need to access read-only data stored in its image layers, such as binaries, libraries, scripts, configuration files, or other resources that are essential for a defined application to function. When accessing data of layer L5 of container image, the runtime container can read data for the depicted read-only directory for layer L5 of container image 200. When reading such data, since the read-only directory for layer L5 for container image 200 has stored therein a replicated reference link as set forth herein, the runtime container for container image 200 can be redirected to the directory for container layer L3 of container image for access of the data.

During the executing of the runtime container instance described as executing at execute block 2110, container host computer environment 210, e.g., via a container virtualization daemon can proceed to delete request decision block 2111. At delete request decision block 2111, container host computer environment 210 can ascertain whether a delete request has been received to delete the container image having a shared layer, i.e., image 100 in the described scenario, which includes layer L3 that is shared with layer L5 of container image 200. On the determination that a delete request has been received, container host computer environment 210 can proceed to lock block 2116 to (when a specified one or more criterion applies) lock out and restrict the deletion of container image 100 based on the described locking mechanism having been raised at specialized processing block 2109. On the determination at block 2111 that a delete request has not been received, container host computer environment 210 can proceed to default processing 2112 and can continue to run the running container without performing any locking.

On completion of block 2116 or block 2112, container host computer environment 210 can proceed to container stop decision block 2113.

At container stop decision block 2113, container host computer environment 210, e.g., via the described container virtualization daemon, can ascertain whether the current executing container, i.e., the described runtime instance of container image 200 is the described scenario, has been stopped.

On the determination that the executing runtime container has been stopped, container host computer environment 210 can proceed to delete decision block 2114 to ascertain whether a container image deletion request is active and if so can proceed to block 2115 to perform specialized deletion processing to selectively and conditionally delete layer data previously established for various one or more container image at specialized processing block 2109. On the determination at block 2114 that no delete request is active, container host computer environment 210 can perform default processing at block 2117. On completion of deletion processing at block 2115 or default processing at block 2117, container host computer environment 210 can proceed to return block 2121.

On the determination at linked layer decision block 2107 that a run request pertains to a container image that is absent a replicated reference link, container host computer environment 210 can perform default processing at block 2108 and can proceed to return block 2121.

At return block 2121, container host computer environment 210 can return to a stage preceding block 2101 and can iteratively perform the loop described with reference to blocks 2101 to block 2121 during a deployment period of container host computer environment 210. On completion of send block 1101, container hub computer environment 110 can proceed to return block 1102. Container hub computer environment 110 can iteratively perform the loop of blocks 1101 to 1102 during a deployment period off container hub computer environment 110. UE devices 120A-120Z can iteratively on completion of block 1202 can proceed to return block 1203. At return block 1203, UE devices 120A-120Z can return to stage preceding block 1201. UE devices 120A-120Z can iteratively perform the loop of blocks 1201 to 1203 during a deployment period of UE devices 120A-120Z.

In another aspect, the operations described with reference to UE devices 120A-120Z can alternatively or additionally be performed by an (application program interface) API endpoint 140 is described in reference to FIG. 1. That is, rather than an administrator user driving, e.g., pull requests, run requests, deletion requests, and/or stop requests and the like in reference to containers images and containers, such request can be generated by automated processes as represented by API service endpoint 140.

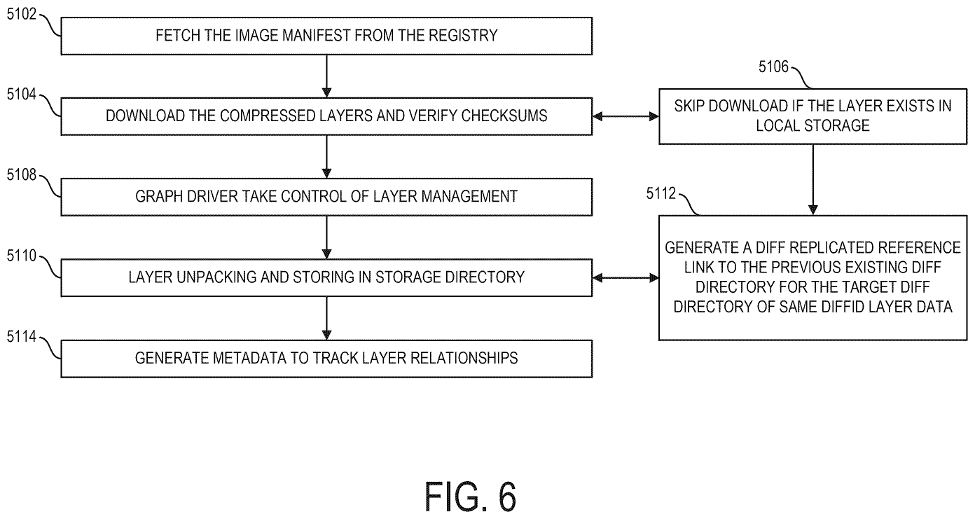

Referring now to FIG. 6, FIG. 6 illustrates container host computer environment 210, (e.g., by a container virtualization daemon) performing specialized processing block 2109 of the flow diagram of FIGS. 3A-3B according to one embodiment.

At block 5102, container host computer environment 210 can fetch an image manifest from manifests registry 22 as shown in FIG. 1. At block 5104, container host computer environment 210 can download compressed layers and verify checksums. At block 5106, container host computer environment 210 can ascertain whether a current layer being downloaded previously exists within container image directories 23 of container host computer environment 210. On the determination at block 5106 that the current layer is a replicate layer of a previously stored layer, container host computer environment 210 can skip download of the layer from container image repository 108 of container hub computer environment 110.

At block 5108, the graph driver (storage driver) of container host computer environment 210 can take control of layer management. At block 5110, container host computer environment 210 can perform layer unpacking and storage of a current layer in an appropriate storage directory of container image directories 23. At block 5112, container host computer environment 210 can generate a diff replicated reference link to the previous existing diff directory for the target diff directory of the same diff ID layer data. At block 5114, container host computer environment 210 can generate metadata files defining shared layer status metadata as set forth in reference to Table A and Table B to track layer relationships.

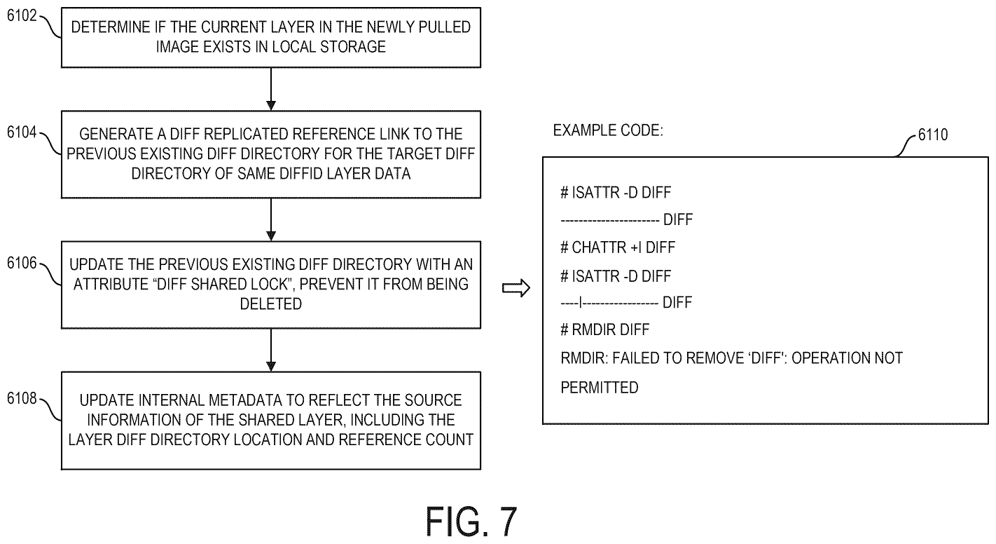

FIG. 7 illustrates further processes that can be performed by container host computer environment 210 at specialized processing block 2109, e.g., by a container virtualization daemon running on container host computer environment 210 in the event that container host computer environment 210 determines that a current layer subject to pulling processing from container image repository 108 is a replicate layer of a layer previously stored within a directory of container image directories 23.

At block 6102, container host computer environment 210 can determine whether the current layer in the newly pulled container image exists in local storage, i.e., in a directory of container image directories 23. At block 6104, on determining that the current layer in the newly pulled container image was previously stored in local storage, i.e., in a directory of container image directories 23, container host computer environment 210 can generate a diff replicated reference link to the previous existing diff directory for the target diff directory of the same diff ID layer data.

At block 6106, container host computer environment 210 can update the previously existing diff directory with an attribute referred to as ‘diff shared lock’ to prevent previous existing shared diff directory from being deleted when a certain one or more criterion applies. At block 6108, container host computer environment 210 can update internal metadata defining shared layer status metadata as set forth in reference to Table A and Table B to reflect the source information of the shared layer including the layer diff directory location and reference count. FIG. 7 depicts example code 6110 for performing updating of the previously existing diff directory of the described attribute of quote “diff shared lock” described at block 6106.

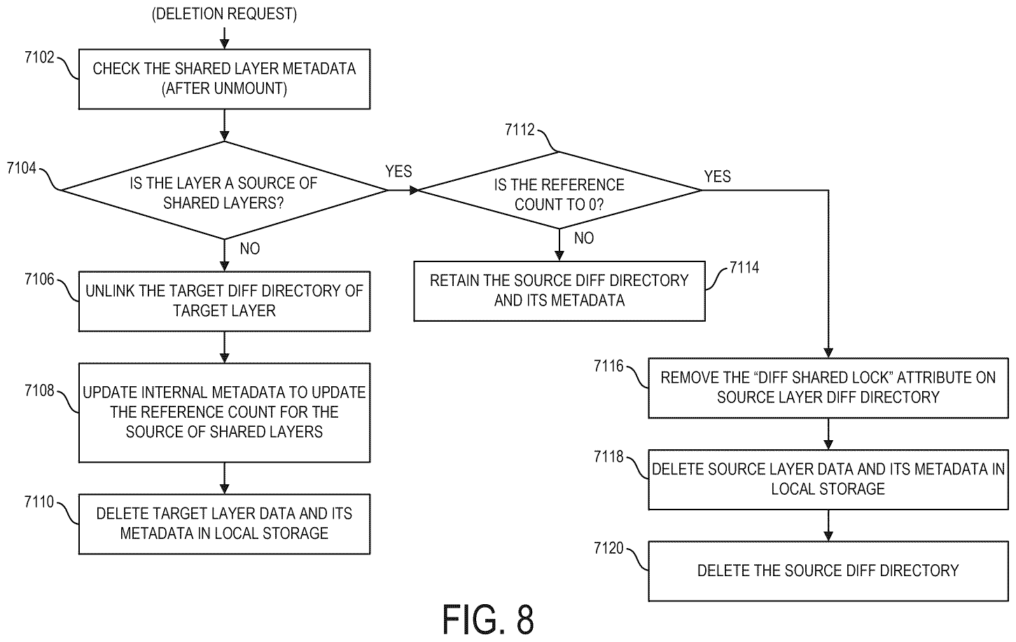

FIG. 8 depicts container host computer environment 210, e.g., by a container virtualization daemon, managing deletion of a container image layer where the container image layer is a shared (replicated) container image layer.

A shared (replicated) container image layers herein can include a source shared container image layer and one or more linked container image layer. The source container image layer can be the initially stored container image layer, e.g., the shared layer 3 container image 100 depicted in FIG. 3, and the one or more linked container image layer herein can refer to a layer that is linked to the source layer by a diff replicated reference link as set forth herein that defines a pointer to the source shared container image layer.

The flowchart of FIG. 8 depicts container host computer environment 210 receiving a request to delete a shared container image layer. At block 7102, container host computer environment 210 can check the shared layer metadata defining shared layer status metadata as set forth in reference to Table A and Table B, e.g., stored in container virtualization root directory 22 to check the status of shared layers pertinent to the request. If the described layer deletion request is received while a runtime instance of a container having a shared layer for which deletion is requested is executing, container host computer environment 210 can delay the performance of block 7102 until the runtime instance has stopped and unmounted. On completion of block 7102, container host computer environment 210 can proceed to decision block 7104.

At decision block 7104, container host computer environment 210 can ascertain whether the layer subject to deletion request is a source container image layer of shared layers based on the checking performed at block 7102. If the layer subject to a deletion request is not a source container image layer, container host computer environment 210 can proceed to block 7106. At block 7106, container host computer environment 210 can unlink the target diff directory of the target layer and then can proceed to block 7108.

At block 7108, container host computer environment 210 can update the internal shared layer metadata defining shared layer status metadata as set forth in reference to Table A and Table B of container virtualization root directory 22 in order to update the reference count for the source of the shared layers. Thus, if the shared layer metadata defining shared layer status metadata as set forth in reference to Table A and Table B indicates that the current reference count of shared linked layers is 3 and the deletion request is a request to delete a linked layer, container host computer environment at block 7108 can decrement the count so that the new reference count is the count 2.

On completion of block 7108, container host computer environment 210 can proceed to block 7110. At block 7110, container host computer environment 210 can delete the target layer data and its metadata defining shared layer status metadata as set forth in reference to Table A and Table B in local storage. In performing block 7110, container host computer environment 210, in one embodiment, can delete read-only diff directory for the linked shared layer. Embodiments herein recognize that a layer deletion request can be defined by a container image request to delete a container image having a shared layer. In such an embodiment, the performance of block 7110 can include deleting all read-only layer diff directories defining storage locations of the container image for which deletion was requested and responded to at block 7102.

On the determination by container host computer environment 210 at decision block 7104 that the layer for which deletion was requested is a source container image layer (and not a linked layer), container host computer environment 210 can proceed to decision block 7112. At decision block 7112, container host computer environment 210 can determine whether the reference count of linked container images that are linked by referencing data to a source container image is at 0. On the determination at block 7102 that the reference count is not at 0, i.e., indicating that there is at least one remaining linked container image layer referencing the source container image layer by a replicated reference link as set forth herein, container host computer environment 210 can proceed to block 7114.

At block 7114, container host computer environment 210 can retain the source container image layer diff directory and its associated metadata defining shared layer status metadata as set forth in reference to Table A and Table B stored in container virtualization root directory 22 so that at block 7114 container host computer environment 110 restricts the deletion of the diff directory for the source container image layer.

On the determination by container host computer environment 210 at decision block 7112 that the reference count of container images referencing the source container image layer by a replicated reference link herein is at 0, container host computer environment 210 can proceed to block 7116. At block 7116, container host computer environment 210 can remove the “diff shared lock” attribute on the source layer diff directory and can proceed to block 7118. At block 7118, container host computer environment 210 can delete the source layer data and its metadata in local storage and can proceed to block 7120. At block 7120, container host computer environment can delete the source diff directory.

FIG. 8 depicts an alternative view of system 1000 as set forth in FIG. 1. System 1000 can include client 802, container virtualization daemon 804 having container virtualization server 808, and container virtualization engine 806. Container virtualization engine 806 can include graph shared layer recycle (GSLR) module 808. Container virtualization engine 806 can be in communication with registry 810. System 1000 can further include driver 820, which can comprise, e.g., graph driver 822, network driver 826, and execution driver 828. Graph driver (storage driver) 822 can include a graph storage de-replication (GSD) module 824 which GSD module 824 can be in communication with graph 830 and container 832. By processes set forth herein, container virtualization daemon 804 can be configured to include GSLR module 808.

In accordance with processes set forth herein, graph driver 822 (storage driver) can be configured in accordance with processes set forth herein. Container virtualization daemon 804 of container host computer environment 210 can be configured to include GSLR module 808 which can perform the layer deletion management processes set forth in reference to FIG. 7 when deletion of a shared container image layer is requested.

In accordance with processes set forth herein, storage driver 822 (graph driver) of container host computer environment 210 can be configured to include a GSD module 824 defining a GSD process which responsively to pulling of a container image from container hub establishes a replicated reference link to a shared container layer directory and can update the shared layer directory to include a locking attribute that restricts deletion of the shared layer directory.

Embodiments herein recognize that according to the state of the art, when two different container images that are based on different base layers, and they both contain a same layer with the same content, the replicated layer will only be pulled once but there will be extracted two copies on Graph/local storage. According to embodiments herein, when we pull two different images that are based on the same base layer, and they both contain a same layer with the same content, the replicated layer will only be pulled once and store a single copy on Graph/local storage.

Embodiments herein can avoid extraction of layer to a layer directory for a target container image being pulled where the certain layer is previously stored layer of a previously stored container image having a base layer differentiated from a base layer of the target container image. Embodiments herein recognize, for example, that in actual product management scenario, there are cases when multiple different products can benefit from the same patch or updates, falling into above situation. Embodiments herein recognize that for the users at the enterprise level, if they have different products installed and apply the same patch to all, the updates are stored with several replicated copies, which takes up extensive amount of storage space. Embodiments herein recognize that the referenced problem is particularly prominent in large-scale and frequently updated projects.

Embodiments herein recognize that when a target image being pulled and a previously stored container image are based on different base layers, a replicate layer of the pulled image that replicates a certain layer of the previously stored image will be extracted twice locally, resulting to the waste of local storage resource. Embodiments herein provide a method that avoids extraction of layer data of replicated layer. Embodiments herein can include referencing the replicate layers of images that are based on different base images, so replicated layers data will only be extracted once locally. Embodiments herein provide an intelligent and convenient method to reference replicated layers. Embodiments herein enable users to store only select layers from various images, even when they originate from different base layers. Embodiments herein significantly optimize local storage utilization, including when managing images for multiple products.

Embodiments herein can provide an intelligent and convenient method to reference replicate layers for the container images which use different base layers in Graph storage of container host computer environment 210, which can optimize local storage utilization as much as possible.

Embodiments herein can include configuring container host computer environment 210 to include a diff replicated reference link (DRRL) that references a shared layer diff directory in Graph storage.

Embodiments herein can include configuring container host computer environment 210 to include a Diff Shared Lock (DSL) attribute. The DSL attribute can be introduced to lock the layer diff directory if it used to be shared.

Embodiments herein can include configuring container host computer environment 210 to include a Graph Storage Dereplication (GSD) process. The GSD process can be introduced into a Graph driver (storage driver) of container host computer environment 210 to generate the described Diff Replicated Reference Link (DRRL) and to control the described Diff Shared Lock (DSL).

Embodiments herein can include configuring container host computer environment 210 to include a Graph Shared Layer Recycle (GSLR) process. The GSLR process can be introduced into container host computer environment 210 to control the shared layer diff data deletion in Graph storage. Such functionality can allow the shared layer of different container images with different base layer to only unpack one copy in local Graph storage after pulling a target container image from remote image registries.

Embodiments herein can include configuring container host computer environment 210 to include a diff replicated reference link (DRRL). The DRRL can reference the shared layer diff directory in Graph storage. In one embodiment, the DRRL can include, e.g., a file or a variable or other that points to a shared layer diff source directory, wherein the shared layer diff directory is a diff directory of certain layer of previously stored container image, wherein the certain layer has been determined to be a replicate layer of a particular layer of the current container image being pulled.

Embodiments herein can include configuring container host computer environment 210 to include a Diff Shared Lock (DSL) attribute. The DSL attribute can be introduced to prevent the layer diff directory from being modified if it used to be shared.

Embodiments herein can include configuring container host computer environment 210 to include a Graph Storage Dereplication (GSD) process. The GSD process defining a GSD module can be introduced into a graph driver (storage driver) of container host computer environment 210 to generate the DRRL and update DSL.

In one aspect, the GSD process can generate shared layer metadata defining shared layer status metadata as set forth in reference to Table A and Table B (including diff reference count and mapping) including by reading image manifests. In one aspect the GSD process can store the described metadata to container virtualization root directory 22 defining a GraphRoot directory. The GSD process can create the diff replicated reference link (DRRL) and update the described Diff Shared Lock (DSL) to the shared layer diff source directory.

Embodiments herein can include configuring container host computer environment 210 to include a Graph Shared Layer Recycle (GSLR) process defining a GSLR. In response to request to delete a shared layer, the GSLR process can perform examining the shared layer status metadata defining shared layer status metadata as set forth in reference to Table A and Table B from GraphRoot, determine whether a diff source directory can be deleted, can update the shared layer status metadata so that the shared layer status metadata defining shared layer status metadata as set forth in reference to Table A and Table B is updated when subsequently queried responsively to a next shared layer deletion request.

FIGS. 4A and 4B show examples of the container filesystem adapted according to methods herein. In reference to the container file system of FIG. 5, layer 5 of image 200 have the same content as layer 3 of image 100. In reference to the container file system of FIG. 5, a reading of layer data of layer 6 of image 200 will be redirected to layer 3 of image 100 via a diff replicated reference link (DRRL) herein. In reference to FIG. 5 there is set forth a flowchart of a modified pull image (with different base layer) process. In reference to FIG. 6, there is set forth generating a Diff Replicated Reference Link (DRRL) to the previous existing diff folder for the target diff folder of same diffID layer data. In reference to FIG. 6, there is set forth a flowchart of a method for unpacking layer data of a target layer when the target layer has the same diffID as a previously stored layer. In reference to FIG. 7, there is set forth a flowchart of a method for deleting layer data when multiple layers have the same diffID.

Certain embodiments herein may offer various technical computing advantages involving computing advantages to address problems arising in the realm of computer systems. Embodiments herein can include features to avoid extraction of layer data stored to a layer directory of a targeted container image being pulled in the case where the layer has been identified as a replicate layer of a previously stored container image layer having a differentiated base layer relative to a base layer of a target image. Embodiments herein can include, during the pulling of a container image from a hub, identifying whether a certain layer of the pulled image has been stored as part of a previously stored container image. The previously stored container image can include a base layer differentiated from a base layer of a target layer image being pulled. On the identification of the replicate layer, a container virtualization daemon of a container host computer environment can store a replicated reference link in a container layer directory for the layer identified to have a previously stored replicate layer in a layer directory for a previously stored image. A replicated reference link can define a pointer to a particular layer directory of the previously stored container image where a particular layer directory is the directory of the identified previously stored replicate layer. Further on the identification of a replicate layer, the container virtualization daemon can establish an attribute that restricts deletion of the source layer having a source layer directory. On receipt of a deletion request to delete a source container image layer, embodiments herein can restrict the deletion in the case that a container virtualization daemon determines that there is at least one active and undeleted linked layer that references the source layer. The container virtualization daemon can qualify the deletion of the source layer conditionally on determining that there are no remaining linked layers linked to the source layer by a replicated reference link referencing the source layer in any stored container image. On receipt of a deletion request to delete a linked container image layer, embodiments herein can perform the deletion, and responsively to such request can update shared layer metadata specifying a status of layers that are shared amongst container images. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes pulling, by a container host computer environment, layer data of container hub stored container layers that define a target container image, where the pulling includes determining that a certain layer of the target container image includes a pre-existing container image layer having pre-existing layer data stored on the container host computer environment, where the pre-existing container image layer is a pre-existing container image layer of a pre-existing container image, where pre-existing layer data defining the pre-existing container image layer is stored in a particular directory of the container host computer environment, and where the target container image includes a base layer differentiated from a base layer of the pre-existing container image; and responsively to the determining that the certain layer of the target container image includes a pre-existing container image layer having pre-existing layer data, creating a replicated reference link, where the replicated reference link defines a pointer to the particular directory of the container host computer environment. Other embodiments of this aspect include corresponding computer systems, apparatus, and computer programs recorded on one or more computer storage devices, each configured to perform the actions of the methods. Implementations may include one or more of the following features. The computer implemented method where the method includes responsively to the determining that the certain layer of the target container image includes a pre-existing container image layer having pre-existing layer data stored within the particular directory, configuring the container host computer environment to restrict deletion of the pre-existing layer data stored within the particular directory. The method includes responsively to the determining that the certain layer of the target container image includes a pre-existing container image layer having pre-existing layer data stored within the particular directory, configuring the container host computer environment to restrict deletion of the particular directory. The method includes receiving a request to delete the pre-existing container image layer, determining, responsively to the receiving the request to delete the pre-existing container image layer, that there is one or more active replicated reference link defining a pointer to the pre-existing container image layer, and restricting deletion of the pre-existing container image layer responsively to the determining that there is one or more active replicated reference link defining a pointer to the pre-existing container image layer. The method includes receiving a request to delete the pre-existing container image layer, discovering, responsively to the receiving the request to delete the pre-existing container image layer, that there is no active replicated reference link defining a pointer to the pre-existing container image layer, qualifying the pre-existing container image layer for deletion responsively to the discovering that there is no active replicated reference link defining a pointer to the pre-existing container image layer, and deleting the pre-existing container image layer responsively to the qualifying. The method includes responsively to the determining that the certain layer of the target container image includes a pre-existing container image layer having pre-existing layer data stored within the particular directory, configuring the container host computer environment to restrict deletion of the pre-existing layer data stored within the particular directory, where the configuring includes updating the particular directory to include an attribute restricting deletion of the pre-existing layer data stored within the particular directory. The method includes responsively to the determining that the certain layer of the target container image includes a pre-existing container image layer having pre-existing layer data stored within the particular directory, configuring the container host computer environment to restrict deletion of the pre-existing layer data stored within the particular directory, where the configuring includes restricting deletion of the pre-existing layer data stored within the particular directory unless one or more criterion is satisfied. The method includes executing a runtime instance of the target container image subsequent to the pulling, where the executing the runtime instance of the target container image subsequent to the pulling includes accessing data of the pre-existing layer data stored within the particular directory using the replicated reference link. The method includes executing a runtime instance of the target container image subsequent to the pulling, where the executing includes establishing a union file system defined by a writable layer and readable layers mounted to the writable layer, where a readable layer of the readable layers includes the replicated reference link. The replicated reference link defines a pointer to the particular directory. Implementations of the described techniques may include hardware, a method or process, or computer software on a computer-accessible medium. The system also includes a memory; at least one processor in communication with the memory; and program instructions executable by one or more processor via the memory to perform a method may include: pulling, by a container host computer environment, layer data of container hub stored container layers that define a target container image, where the pulling includes determining that a certain layer of the target container image includes a pre-existing container image layer having pre-existing layer data stored on the container host computer environment, where the pre-existing container image layer is a pre-existing container image layer of a pre-existing container image, where pre-existing layer data defining the pre-existing container image layer is stored in a particular directory of the container host computer environment, and where the target container image includes a base layer differentiated from a base layer of the pre-existing container image; and responsively to the determining that the certain layer of the target container image includes a pre-existing container image layer having pre-existing layer data, creating a replicated reference link, where the replicated reference link defines a pointer to the particular directory of the container host computer environment. Other embodiments of this aspect include corresponding computer systems, apparatus, and computer programs recorded on one or more computer storage devices, each configured to perform the actions of the methods. Implementations may include one or more of the following features. The system where the method includes responsively to the determining that the certain layer of the target container image includes a pre-existing container image layer having pre-existing layer data stored within the particular directory, configuring the container host computer environment to restrict deletion of the pre-existing layer data stored within the particular directory. The method includes responsively to the determining that the certain layer of the target container image includes a pre-existing container image layer having pre-existing layer data stored within the particular directory, configuring the container host computer environment to restrict deletion of the particular directory. The method includes receiving a request to delete the pre-existing container image layer, determining, responsively to the receiving the request to delete the pre-existing container image layer, that there is one or more active replicated reference link defining a pointer to the pre-existing container image layer, and restricting deletion of the pre-existing container image layer responsively to the determining that there is one or more active replicated reference link defining a pointer to the pre-existing container image layer. The method includes receiving a request to delete the pre-existing container image layer, discovering, responsively to the receiving the request to delete the pre-existing container image layer, that there is no active replicated reference link defining a pointer to the pre-existing container image layer, qualifying the pre-existing container image layer for deletion responsively to the discovering that there is no active replicated reference link defining a pointer to the pre-existing container image layer, and deleting the pre-existing container image layer responsively to the qualifying. The method includes responsively to the determining that the certain layer of the target container image includes a pre-existing container image layer having pre-existing layer data stored within the particular directory, configuring the container host computer environment to restrict deletion of the pre-existing layer data stored within the particular directory, where the configuring includes updating the particular directory to include an attribute restricting deletion of the pre-existing layer data stored within the particular directory. The method includes responsively to the determining that the certain layer of the target container image includes a pre-existing container image layer having pre-existing layer data stored within the particular directory, configuring the container host computer environment to restrict deletion of the pre-existing layer data stored within the particular directory, where the configuring includes restricting deletion of the pre-existing layer data stored within the particular directory unless one or more criterion is satisfied. The method includes executing a runtime instance of the target container image subsequent to the pulling, where the executing the runtime instance of the target container image subsequent to the pulling includes accessing data of the pre-existing layer data stored within the particular directory using the replicated reference link. The method includes executing a runtime instance of the target container image subsequent to the pulling, where the executing includes establishing a union file system defined by a writable layer and readable layers mounted to the writable layer, where a readable layer of the readable layers includes the replicated reference link. Implementations of the described techniques may include hardware, a method or process, or computer software on a computer-accessible medium. One general aspect includes a computer readable storage medium readable by one or more processing circuit and storing instructions for execution by one or more processor for performing. The computer program product also includes pulling, by a container host computer environment, layer data of container hub stored container layers that define a target container image, where the pulling includes determining that a certain layer of the target container image includes a pre-existing container image layer having pre-existing layer data stored on the container host computer environment, where the pre-existing container image layer is a pre-existing container image layer of a pre-existing container image, where pre-existing layer data defining the pre-existing container image layer is stored in a particular directory of the container host computer environment, and where the target container image includes a base layer differentiated from a base layer of the pre-existing container image; and responsively to the determining that the certain layer of the target container image includes a pre-existing container image layer having pre-existing layer data, creating a replicated reference link, where the replicated reference link defines a pointer to the particular directory of the container host computer environment. Other embodiments of this aspect include corresponding computer systems, apparatus, and computer programs recorded on one or more computer storage devices, each configured to perform the actions of the methods.

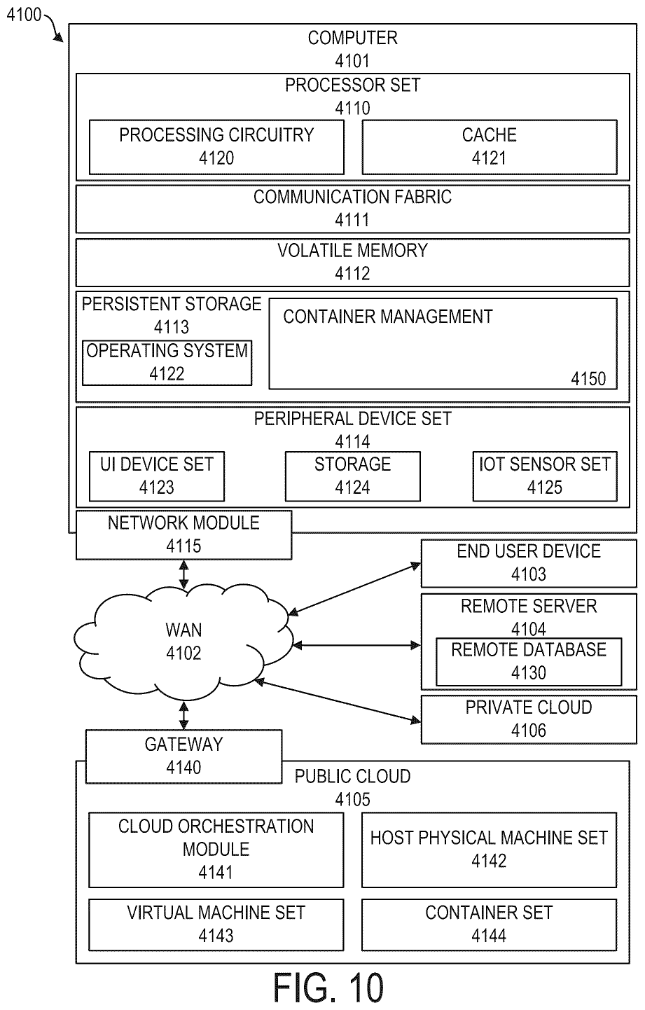

In reference to FIG. 10 there is set forth a description of a computing environment 4100 that can include one or more computer 4101. In one example, computing node 10 as set forth herein can be provided in accordance with computer 4101 as set forth in FIG. 10.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

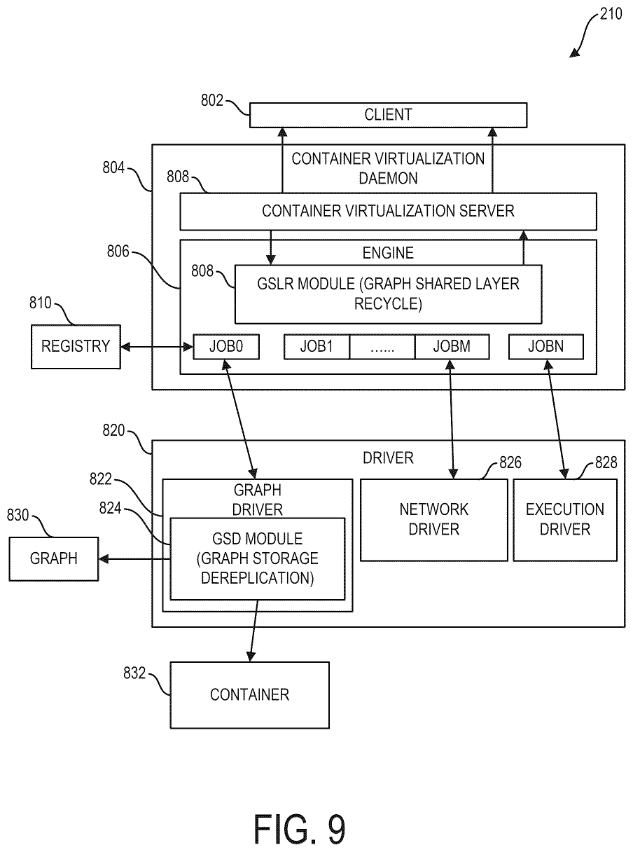

One example of a computing environment to perform, incorporate and/or use one or more aspects of the present invention is described with reference to FIG. 10. In one aspect, a computing environment 4100 contains an example of an environment for the execution of at least some of the computer code involved in performing the inventive methods, such as code 4150 for performing container management processing as described with reference to FIGS. 1-9. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IOT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 10. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
pulling, by a container host computer environment, layer data of container hub stored container layers that define a target container image, wherein the pulling includes determining that a certain layer of the target container image includes a pre-existing container image layer having pre-existing layer data stored on the container host computer environment, wherein the pre-existing container image layer is a pre-existing container image layer of a pre-existing container image, wherein pre-existing layer data defining the pre-existing container image layer is stored in a particular directory of the container host computer environment, and wherein the target container image includes a base layer differentiated from a base layer of the pre-existing container image; and
responsively to the determining that the certain layer of the target container image includes a pre-existing container image layer having pre-existing layer data, creating a replicated reference link, wherein the replicated reference link defines a pointer to the particular directory of the container host computer environment.

2. The computer implemented method of claim 1, wherein the method includes responsively to the determining that the certain layer of the target container image includes a pre-existing container image layer having pre-existing layer data stored within the particular directory, configuring the container host computer environment to restrict deletion of the pre-existing layer data stored within the particular directory.

3. The computer implemented method of claim 1, wherein the method includes responsively to the determining that the certain layer of the target container image includes a pre-existing container image layer having pre-existing layer data stored within the particular directory, configuring the container host computer environment to restrict deletion of the particular directory.

4. The computer implemented method of claim 1, wherein the method includes receiving a request to delete the pre-existing container image layer, determining, responsively to the receiving the request to delete the pre-existing container image layer, that there is one or more active replicated reference link defining a pointer to the pre-existing container image layer, and restricting deletion of the pre-existing container image layer responsively to the determining that there is one or more active replicated reference link defining a pointer to the pre-existing container image layer.

5. The computer implemented method of claim 1, wherein the method includes receiving a request to delete the pre-existing container image layer, discovering, responsively to the receiving the request to delete the pre-existing container image layer, that there is no active replicated reference link defining a pointer to the pre-existing container image layer, qualifying the pre-existing container image layer for deletion responsively to the discovering that there is no active replicated reference link defining a pointer to the pre-existing container image layer, and deleting the pre-existing container image layer responsively to the qualifying.

6. The computer implemented method of claim 1, wherein the method includes responsively to the determining that the certain layer of the target container image includes a pre-existing container image layer having pre-existing layer data stored within the particular directory, configuring the container host computer environment to restrict deletion of the pre-existing layer data stored within the particular directory, wherein the configuring includes updating the particular directory to include an attribute restricting deletion of the pre-existing layer data stored within the particular directory.

7. The computer implemented method of claim 1, wherein the method includes responsively to the determining that the certain layer of the target container image includes a pre-existing container image layer having pre-existing layer data stored within the particular directory, configuring the container host computer environment to restrict deletion of the pre-existing layer data stored within the particular directory, wherein the configuring includes restricting deletion of the pre-existing layer data stored within the particular directory unless one or more criterion is satisfied.

8. The computer implemented method of claim 1, wherein the method includes executing a runtime instance of the target container image subsequent to the pulling, wherein the executing the runtime instance of the target container image subsequent to the pulling includes accessing data of the pre-existing layer data stored within the particular directory using the replicated reference link.

9. The computer implemented method of claim 1, wherein the method includes executing a runtime instance of the target container image subsequent to the pulling, wherein the executing includes establishing a union file system defined by a writable layer and readable layers mounted to the writable layer, wherein a readable layer of the readable layers includes the replicated reference link.

10. The computer implemented method of claim 1, wherein the replicated reference link defines a pointer to the particular directory.

11. A system comprising:
a memory;
at least one processor in communication with the memory; and
program instructions executable by one or more processor via the memory to perform a method comprising:
pulling, by a container host computer environment, layer data of container hub stored container layers that define a target container image, wherein the pulling includes determining that a certain layer of the target container image includes a pre-existing container image layer having pre-existing layer data stored on the container host computer environment, wherein the pre-existing container image layer is a pre-existing container image layer of a pre-existing container image, wherein pre-existing layer data defining the pre-existing container image layer is stored in a particular directory of the container host computer environment, and wherein the target container image includes a base layer differentiated from a base layer of the pre-existing container image; and
responsively to the determining that the certain layer of the target container image includes a pre-existing container image layer having pre-existing layer data, creating a replicated reference link, wherein the replicated reference link defines a pointer to the particular directory of the container host computer environment.

12. The system of claim 11, wherein the method includes responsively to the determining that the certain layer of the target container image includes a pre-existing container image layer having pre-existing layer data stored within the particular directory, configuring the container host computer environment to restrict deletion of the pre-existing layer data stored within the particular directory.

13. The system of claim 11, wherein the method includes responsively to the determining that the certain layer of the target container image includes a pre-existing container image layer having pre-existing layer data stored within the particular directory, configuring the container host computer environment to restrict deletion of the particular directory.

14. The system of claim 11, wherein the method includes receiving a request to delete the pre-existing container image layer, determining, responsively to the receiving the request to delete the pre-existing container image layer, that there is one or more active replicated reference link defining a pointer to the pre-existing container image layer, and restricting deletion of the pre-existing container image layer responsively to the determining that there is one or more active replicated reference link defining a pointer to the pre-existing container image layer.

15. The system of claim 11, wherein the method includes receiving a request to delete the pre-existing container image layer, discovering, responsively to the receiving the request to delete the pre-existing container image layer, that there is no active replicated reference link defining a pointer to the pre-existing container image layer, qualifying the pre-existing container image layer for deletion responsively to the discovering that there is no active replicated reference link defining a pointer to the pre-existing container image layer, and deleting the pre-existing container image layer responsively to the qualifying.

16. The system of claim 11, wherein the method includes responsively to the determining that the certain layer of the target container image includes a pre-existing container image layer having pre-existing layer data stored within the particular directory, configuring the container host computer environment to restrict deletion of the pre-existing layer data stored within the particular directory, wherein the configuring includes updating the particular directory to include an attribute restricting deletion of the pre-existing layer data stored within the particular directory.

17. The system of claim 11, wherein the method includes responsively to the determining that the certain layer of the target container image includes a pre-existing container image layer having pre-existing layer data stored within the particular directory, configuring the container host computer environment to restrict deletion of the pre-existing layer data stored within the particular directory, wherein the configuring includes restricting deletion of the pre-existing layer data stored within the particular directory unless one or more criterion is satisfied.

18. The system of claim 11, wherein the method includes executing a runtime instance of the target container image subsequent to the pulling, wherein the executing the runtime instance of the target container image subsequent to the pulling includes accessing data of the pre-existing layer data stored within the particular directory using the replicated reference link.

19. The system of claim 11, wherein the method includes executing a runtime instance of the target container image subsequent to the pulling, wherein the executing includes establishing a union file system defined by a writable layer and readable layers mounted to the writable layer, wherein a readable layer of the readable layers includes the replicated reference link.

20. A computer program product comprising:
a computer readable storage medium readable by one or more processing circuit and storing instructions for execution by one or more processor for performing a method comprising:
pulling, by a container host computer environment, layer data of container hub stored container layers that define a target container image, wherein the pulling includes determining that a certain layer of the target container image includes a pre-existing container image layer having pre-existing layer data stored on the container host computer environment, wherein the pre-existing container image layer is a pre-existing container image layer of a pre-existing container image, wherein pre-existing layer data defining the pre-existing container image layer is stored in a particular directory of the container host computer environment, and wherein the target container image includes a base layer differentiated from a base layer of the pre-existing container image; and
responsively to the determining that the certain layer of the target container image includes a pre-existing container image layer having pre-existing layer data, creating a replicated reference link, wherein the replicated reference link defines a pointer to the particular directory of the container host computer environment.
